(19) United States
(12) Patent Application Publication
(10) Pub. No.: US 2026/0133136 A1
(43) Pub. Date: May 14, 2026

(54) WAFER INSPECTION SYSTEM AND METHOD THEREOF

(71) Applicant: TA LIANG TECHNOLOGY CO., LTD., Taoyuan City (TW)

(72) Inventors: Tsung-De CHANG, Taoyuan City (TW); Jun-You GUO, Taoyuan City (TW)

(73) Assignee: TA LIANG TECHNOLOGY CO., LTD., Taoyuan City (TW)

(21) Appl. No.: 18/982,538

(22) Filed: Dec. 16, 2024

(30) Foreign Application Priority Data
Nov. 11, 2024 (TW) 113143221

(51) Int. Cl. G01N 21/88; G01N 21/95

(52) U.S. Cl. CPC G01N 21/8851; G01N 21/8806; G01N 21/9503; G01N 2021/8841; G01N 2021/8861

(57) ABSTRACT

A wafer inspection system and an inspecting method thereof are provided. The wafer inspection system uses an upper back projection module and a lower back projection module of a coaxial back projection imaging device to guide a coaxial light to an upper side and a lower side of a peripheral edge of each of stacked wafers and obtain a front back projection image and a rear back projection image of the peripheral edge respectively, and then the coordinate systems of the two images are converted into the same coordinate system. In addition, the wafer inspection system also uses a side-light imaging device to guide the side light emitted by the side-light imaging device to the sides of the peripheral edges of the stacked wafers, thereby obtaining high-contrast images of the peripheral edges.

### BACKGROUND

### 1. Technical Field

The present disclosure relates to a wafer inspection technology, and more particularly, to a wafer inspection system and a method of using the wafer inspection system.

### 2. Description of Related Art

In the current semiconductor industry, as semiconductor chips become faster and larger in capacity, the technology of bonding multiple semiconductor wafers to obtain stacked wafers has been widely used. Stacked wafers can have complex edge profiles, so it is necessary to determine the correct diameter or center position of the semiconductor wafer to position the wafer with optimal accuracy.

Further, stacked wafers with fabrication variations can cause problems during manufacturing. For example, stacked wafers with edge profiles not meeting specifications can pose a risk during chemical mechanical polishing, other processing steps, or wafer handling. In addition, during chemical mechanical polishing, the placement of the polishing pad relative to the center of the stacked wafers and subsequent planarization will be affected by the centrality of the stacked wafers, and improper centrality can even destroy the stacked wafers or damage the manufacturing equipment.

To this end, in the conventional technology, a projection module is usually used to observe the profile of each bonded semiconductor wafer to calculate the notch direction, and measure the rotation angle of each bonded semiconductor wafer, or it may be necessary to create a diffraction lattice-like pattern on the semiconductor wafer in advance. However, in the conventional technology, only the edge and wafer offset of a single wafer or a double-layer wafer carrier are measured by the side projection module, and the precise center offset and offset angle cannot be estimated. Furthermore, if the angle between the double-layer wafer is merely imaged from one side, the estimated approximate angle variation will be larger (virtual profile arc length and side view arc length methods).

Therefore, how to propose a wafer inspection technology that can obtain accurate notch position, notch angle, wafer center and the trend of overall wafer outer edge offset has become an urgent issue in the industry.

### SUMMARY

In view of the aforementioned shortcomings of the prior art, the present disclosure provides a wafer inspection system, which comprises: a first platform for placing a target object thereon; a second platform moveable relative to the first platform, wherein the target object on the first platform is moveable relative to the second platform; a third platform moveable relative to the first platform and located on a side of the second platform; a coaxial back projection imaging device including an upper back projection module and a lower back projection module disposed on the second platform, wherein a coaxial light is guided to an upper side and a lower side of a peripheral edge of the target object by the upper back projection module and the lower back projection module to obtain a front back projection image and a rear back projection image of the peripheral edge respectively; and a side-light imaging device disposed on the third platform, wherein a side light emitted by the side-light imaging device is guided to a side of the peripheral edge of the target object to obtain a contrast image of the peripheral edge.

In one embodiment of the present disclosure, the upper back projection module and the lower back projection module each has a corresponding light splitting element, coaxial light source and imaging element, wherein between the peripheral edge and the corresponding light splitting element and the coaxial light source is formed with a first imaging path, and between the corresponding light splitting element and the imaging element is formed with a second imaging path.

In one embodiment of the present disclosure, the coaxial light sources of the upper back projection module and the lower back projection module are relatively disposed on a same axis, and the light splitting elements of the upper back projection module and the lower back projection module are disposed between the coaxial light sources on the axis.

In one embodiment of the present disclosure, the first imaging paths of the upper back projection module and the lower back projection module are respectively perpendicular to the second imaging paths of the upper back projection module and the lower back projection module.

In one embodiment of the present disclosure, the wafer inspection system further comprises a coordinate calibration device having at least two targets, a front calibration target projection image window, and a rear calibration target projection image window, allowing the front back projection image and the rear back projection image to be formed with at least two reference points, wherein the front back projection image and the rear back projection image are converted into coplanar coordinates via the at least two reference points. Further, the coordinate calibration device is disposed on the third platform and adjacent to the side-light imaging device.

In one embodiment of the present disclosure, the side-light imaging device has a side light source and an image capturing element, wherein the side light source, the image capturing element and the peripheral edge form a third imaging path.

The present disclosure also provides a method of inspecting a wafer, the method comprises: providing the wafer inspection system as described above; disposing stacked upper wafer and lower wafer on the first platform; obtaining a front back projection image and a rear back projection image of peripheral edges of the upper wafer and the lower wafer by the coaxial back projection imaging device; obtaining a contrast image of the peripheral edges of the upper wafer and the lower wafer by the side-light imaging device; detecting the front back projection image, the rear back projection image and the contrast image to obtain coordinates of notch vertices and coordinates of a plurality of feature points of the peripheral edges of the upper wafer and the lower wafer from the front back projection image, the rear back projection image and the contrast image; calculating coordinates of a center of the upper wafer and the lower wafer respectively via the coordinates of the plurality of feature points; and calculating a positional offset between the upper wafer and the lower wafer via the coordinates of the notch vertices and the coordinates of the centers.

In one embodiment of the present disclosure, the coordinates of the notch vertex and the coordinates of the center of the upper wafer form a first straight line, and the coordinates of the notch vertex and the coordinates of the center of the lower wafer form a second straight line, allowing an included angle value to be calculated via a slope of the first straight line and a slope of the second straight line.

In one embodiment of the present disclosure, between the coordinates of the notch vertex of the upper wafer and the coordinates of the notch vertex of the lower wafer has a connecting arc length value, allowing an included angle value to be calculated via a ratio of the connecting arc length value and a difference between a radius length and a notch height of the upper wafer and the lower wafer.

As can be understood from the above, the wafer inspection system of the present disclosure uses the upper back projection module and the lower back projection module of the coaxial back projection imaging device to guide the coaxial light to the upper and lower sides of the peripheral edges of the stacked wafers to respectively obtain the front back projection images and the rear back projection images of the peripheral edges, and the coordinate systems of the front back projection images and the rear back projection images are converted into the same coordinate system to accurately calculate the position of the notch, the angle of the notch, the center of the wafer and the trend of overall wafer outer edge offset. In addition, the present disclosure also uses a side-light imaging device to guide the side light emitted by the side-light imaging device to the sides of the peripheral edges of the stacked wafers, thereby acquiring high-contrast images of the peripheral edges.

### BRIEF DESCRIPTION OF THE DRAWINGS

FIG. 1 is a schematic diagram of a wafer inspection system according to the present disclosure.

FIG. 2 is a schematic diagram of a configuration of a coaxial back projection imaging device and a coordinate calibration device according to the present disclosure.

FIG. 3A and FIG. 3B are schematic diagrams of front and rear back projection images with calibration targets according to the present disclosure.

FIG. 3C is a schematic diagram of a coordinate calibration device according to the present disclosure.

FIG. 4A to FIG. 4C are schematic diagrams illustrating a coordinate coplanar transformation of a front back projection image according to the present disclosure.

FIG. 5A to FIG. 5D are schematic diagrams illustrating a coordinate coplanar transformation of a rear back projection image according to the present disclosure.

FIG. 6 is a schematic diagram illustrating a coordinate coplanar result of the front back projection image and the rear back projection image according to the present disclosure.

FIG. 7 is a schematic diagram of sampling points of circle given three points of the stacked wafer according to the present disclosure.

FIG. 8 is a schematic diagram of circle given three points of stacked wafers according to the present disclosure.

FIG. 9A is a schematic diagram illustrating a calculation of center offset of stacked wafers according to the present disclosure.

FIG. 9B is a schematic diagram illustrating a calculation of intersection angle of slope of the notches of stacked wafers according to the present disclosure.

FIG. 9C is a schematic diagram illustrating a notch image arc length approximation method of stacked wafers according to the present disclosure.

### DETAILED DESCRIPTION

Implementations of the present disclosure are described below by embodiments. Other advantages and technical effects of the present disclosure can be readily understood by one of ordinary skill in the art upon reading the disclosure of this specification.

It should be noted that the structures, ratios, sizes shown in the drawings appended to this specification are provided in conjunction with the disclosure of this specification in order to facilitate understanding by those skilled in the art. They are not meant, in any ways, to limit the implementations of the present disclosure, and therefore have no substantial technical meaning. Without influencing the effects created and objectives achieved by the present disclosure, any modifications, changes, or adjustments to the structures, ratios, or sizes are construed as falling within the scope covered by the technical contents disclosed herein. Meanwhile, terms such as “first,” “second,” “a,” “one,” “on,” “below” and the like, are for illustrative purposes, and are not meant to limit the scope implementable by the present disclosure. Any changes or adjustments made to the relative relationships, without substantially modifying the technical contents, are also to be construed as within the scope implementable by the present disclosure.

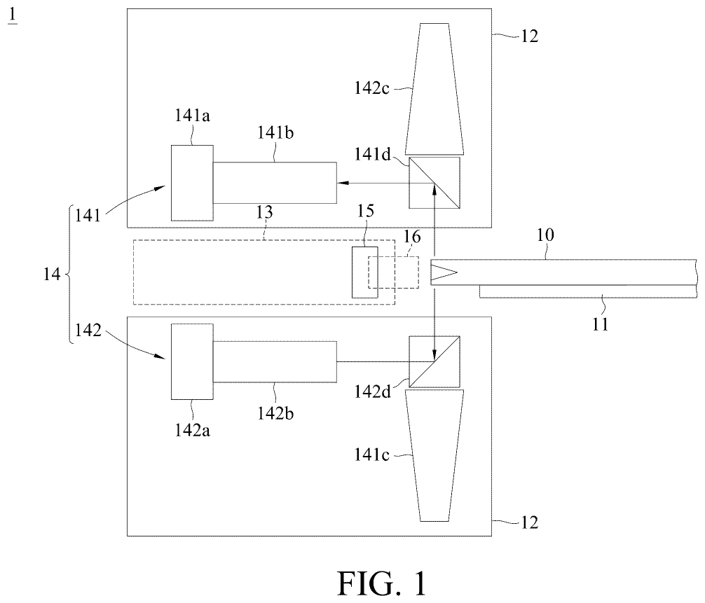

FIG. 1 is a schematic diagram of a wafer inspection system 1 according to the present disclosure. The wafer inspection system 1 includes: a first platform 11, a second platform 12, a third platform 13, a coaxial back projection imaging device 14 disposed on the second platform 12, and a side-light imaging device 15 disposed on the third platform 13.

Further, the second platform 12 is movable relative to the first platform 11, and the third platform 13 is also movable relative to the first platform 11 and is located on a side of the second platform 12.

As shown in FIG. 1, the coaxial back projection imaging device 14 includes an upper back projection module 141 and a lower back projection module 142 disposed on the second platform 12, wherein the upper back projection module 141 includes a first imaging element 141a, a first lens element 141b, a first coaxial light source 141c and a first light splitting element 141d, and the lower back projection module 142 includes a second imaging element 142a, a second lens element 142b, a second coaxial light source 142c and a second light splitting element 142d.

In one embodiment, as shown in FIG. 1, a target object 10, such as stacked wafers, can be disposed on the first platform 11, so that the target object 10 is moveable relative to the second platform 12, and the first coaxial light source 141c and the first light splitting element 141d or the second coaxial light source 142c and the second light splitting element 142d located on the second platform 12 are aligned with a peripheral edge of the target object 10.

Thereby, a first imaging path can be formed between the peripheral edge of the target object 10, the first coaxial light source 141c and the first light splitting element 141d to guide a coaxial light to above the peripheral edge of the target object 10. A second imaging path can be formed between the first light splitting element 141d and the first imaging element 141a.

Similarly, a first imaging path can be formed between the peripheral edge of the target object 10, the second coaxial light source 142c and the second light splitting element 142d to guide the coaxial light to below the peripheral edge of the target object 10. A second imaging path can be formed between the second light splitting element 142d and the second imaging element 142a.

More specifically, in some embodiments, the peripheral edge of the target object 10 is arranged between the first coaxial light source 141c and the first light splitting element 141d on the first imaging path, and is also arranged between the second coaxial light source 142c and the second light splitting element 142d on the first imaging path. Thereby, a projection of the peripheral edge of the target object 10 formed by the first coaxial light source 141c or the second coaxial light source 142c is projected to the first light splitting element 141d or the second light splitting element 142d, and is reflected to the first imaging element 141a or the second imaging element 142a through the second imaging path, so as to obtain a front back projection image and a rear back projection image of the peripheral edge of the target object 10 respectively.

Furthermore, the first coaxial light source 141c of the upper back projection module 141 and the second coaxial light source 142c of the lower back projection module 142 are relatively disposed on a same axis, and the first light splitting element 141d of the upper back projection module 141 and the second light splitting element 142d of the lower back projection module 142 are disposed between the first coaxial light source 141c and the second coaxial light source 142c on the axis. In other words, the first imaging path of the upper back projection module 141 and the first imaging path of the lower back projection module 142 are arranged on the same axis.

In some embodiments, as shown in FIG. 1, the first imaging paths of the upper back projection module 141 and the lower back projection module 142 are perpendicular to the second imaging paths of the upper back projection module 141 and the lower back projection module 142 respectively. In other words, the axis of the first imaging element 141a of the upper back projection module 141 is perpendicular to the axis of the first coaxial light source 141c, and the axis of the second imaging element 142a of the lower back projection module 142 is perpendicular to the axis of the second coaxial light source 142c.

Further, in some embodiments, the upper back projection module 141 further includes an imaging path of which light from the second coaxial light source 142c passing through the first light splitting element 141d to the peripheral edge of the target object 10 and then being reflected by the first light splitting element 141d to the upper back projection module 141, and the lower back projection module 142 further includes an imaging path of which light from the first coaxial light source 141c passing through the second light splitting element 142d to the peripheral edge of the target object 10 and then being reflected by the second light splitting element 142d to the lower back projection module 142.

In one embodiment, as shown in FIG. 1, the side-light imaging device 15 disposed on the third platform 13 guides the side light emitted by the side-light imaging device to a side of the peripheral edge of the target object 10 along a third imaging path to acquire a high-contrast image of the peripheral edge. In some embodiments, the side-light imaging device 15 has a side light source and an image capturing element (not shown), thereby the third imaging path is formed by the side light source, the image capturing element and the peripheral edge.

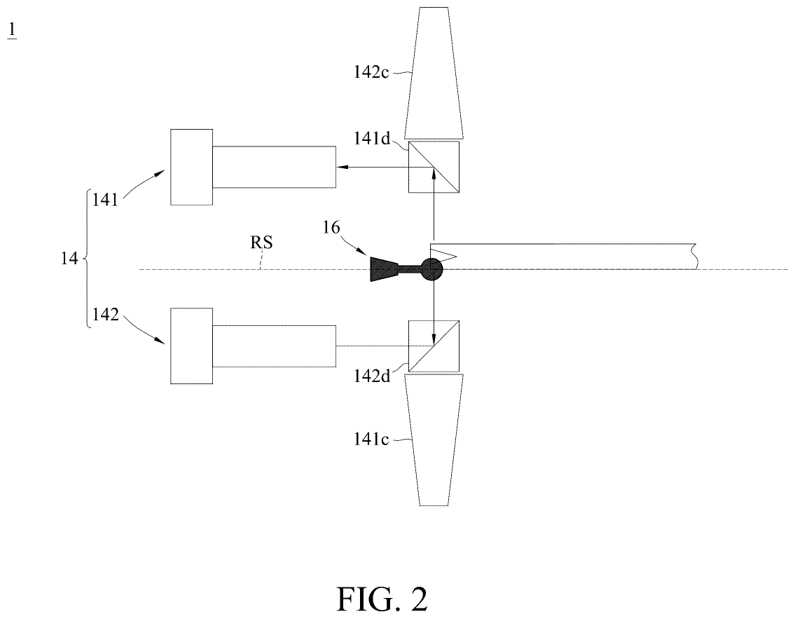

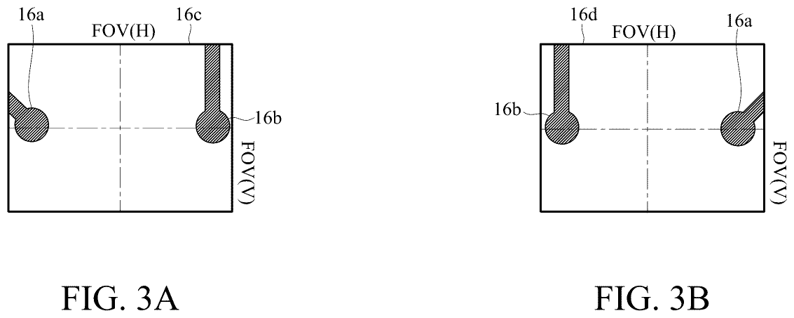

FIG. 2 is a schematic diagram of a configuration of the coaxial back projection imaging device 14 and a coordinate calibration device 16 according to the present disclosure. FIG. 3A and FIG. 3B are schematic diagrams of front and rear back projection images with calibration targets according to the present disclosure. FIG. 3C is a schematic diagram of a coordinate calibration device according to the present disclosure. In some embodiments, the wafer inspection system 1 further includes the coordinate calibration device 16 disposed on a reference plane RS where the first platform 11 is located, allowing the coordinate calibration device 16 to be on the same level with the peripheral edge of the target object 10. Specifically, the coordinate calibration device 16 is disposed on a plane illuminated by the first coaxial light source 141c of the upper back projection module 141 and the second coaxial light source 142c of the lower back projection module 142.

In one embodiment, the coordinate calibration device 16 has at least two calibration targets 16a, 16b, a front calibration target projection image window 16c, a rear calibration target projection image window 16d (and/or a calibration card), thereby the front back projection image and the rear back projection image are imaged with at least two reference points, as shown in FIG. 3A and FIG. 3B respectively, and the front back projection image and the rear back projection image are converted into coplanar coordinates via the at least two reference points.

As shown in FIG. 3A, the calibration target 16a is located at a left position of the front calibration target projection image window 16c when viewing from the front back projection image. Correspondingly, as shown in FIG. 3B, the calibration target 16a is located at a right position of the rear calibration target projection image window 16d when viewing from the rear back projection image. Accordingly, a mirror image relationship is between the front back projection image and the rear back projection image.

In some embodiments, as shown in FIG. 3C, the calibration target 16a of the coordinate calibration device 16 is arranged at a 45 degree angle relative to the calibration target 16b and projected onto the front calibration target projection image window 16c, and the calibration target 16b of the coordinate calibration device 16 is arranged parallel to a vertical axis of the front calibration target projection image window 16c and projected onto the front calibration target projection image window 16c. In other words, a projection of a pole part of the calibration target 16a and a projection of a pole part of the calibration target 16b form a 45 degree angle in the front calibration target projection image window 16c, and the at least two reference points provided by the calibration target 16a and the calibration target 16b are located on a horizontal axis of the front calibration target projection image window 16c.

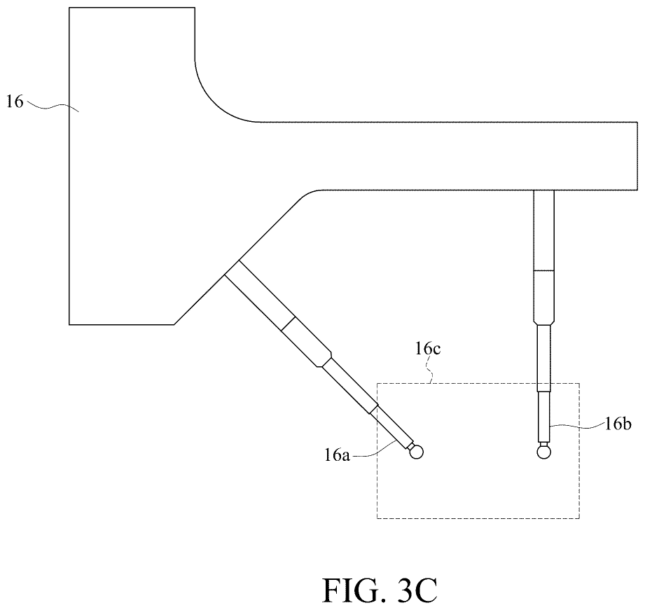

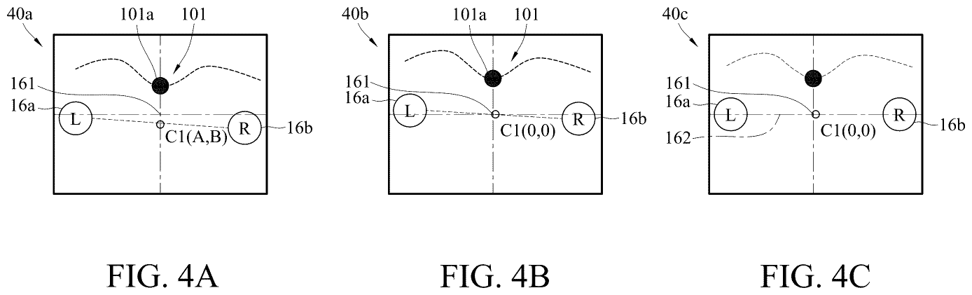

FIG. 4A to FIG. 4C are schematic diagrams illustrating a coordinate coplanar transformation of the front back projection image according to the present disclosure. FIG. 4A shows a front back projection image 40a obtained by the first imaging element 141a of the upper back projection module 141. The front back projection image 40a includes the calibration target 16a on the left, the calibration target 16b on the right, and a notch 101 on the peripheral edge of the target object 10. The notch 101 has a notch vertex 101a, and the coordinates (A, B) of a midpoint C1 is obtained via the coordinates of the calibration target 16a and the coordinates of the calibration target 16b.

Then, by moving the coordinates (A, B) of the midpoint C1 to a calibration origin 161 of the front calibration target projection image window 16c, the calibration target 16a, the calibration target 16b, the notch 101 and the notch vertex 101a on the peripheral edge of the target object 10 are moved synchronously to complete a coordinate translation transformation of the image to obtain a translation front back projection image 40b as shown in FIG. 4B (that is, a (X, Y) coordinate system is transformed into a (X′, Y′) coordinate system).

In one embodiment, the coordinate translation transformation is calculated as follows:
coordinates of a point A of the calibration target 16a are (a1x, a1y),
coordinates of a point B of the calibration target 16b are (b1x, b1y),
coordinates of a point N1 of the notch vertex 101a are (n1x, n1y),
coordinates of the midpoint C1 are [(a1x+b1x)/2, (a1y+b1y)/2],
next, assume that the coordinates of the midpoint C1 are translated to the position of (0, 0) (and the calibration origin 161),
and the translation amounts are dx=−(a1x+b1x)/2, dy=−(a1y+b1y)/2.

The new coordinates after translation can be expressed as (a1x+dx, a1y+dy) for the point A of the calibration target 16a, (b1x+dx, b1y+dy) for the point B of the calibration target 16b, and (n1x+dx, n1y+dy) for the point N1 of the notch vertex 101a.

After substituting the translation amounts dx and dy, the new coordinates are [(a1x−b1x)/2, (a1y−b1y)/2)] for the point A of the calibration target 16a, [(−a1x+b1x)/2, (−a1y+b1y)/2] for the point B of the calibration target 16b, and [n1x−(a1x+b1x)/2, n1y−(a1y+b1y)/2] for the point N1 of the notch vertex 101a.

Finally, by taking the midpoint C1(0, 0) as the origin, the calibration target 16a and the calibration target 16b are rotated to a calibration horizontal axis 162, and the notch 101 and the notch vertex 101a of the peripheral edge of the target object 10 are synchronously rotated and converted, thereby completing a coordinate rotation transformation of the image to obtain a rotated front back projection image 40c as shown in FIG. 4C (that is, the (X′, Y′) coordinate system is converted to a (X′″, Y′″) coordinate system).

In one embodiment, the coordinate rotation transformation is calculated as follows:
a slope of the calibration target 16a and the calibration target 16b is k1=(b1x-a1x)/(b1y−a1y),
an angle from the calibration horizontal axis 162 is θ1=tan⁻¹(k1) or 180-θ1,
the coordinates of any point in the (X′, Y′) coordinate system are converted into the (X′″, Y′″) coordinate system,
which can be expressed as

X′″=X′x cos θ−Y′x sin θ,

Y′″=X′x sin θ+Y′x cos θ.

Accordingly, the coordinate rotation transformation of the point N1 in the (X′″, Y′″) coordinate system can be expressed as

X′″=[n1x−(a1x+b1x)/2]×cos θ−n1y−(a1y+b1y)/2×sin θ,

Y′″=[n1x−(a1x+b1x)/2]×sin θ+n1y−(a1y+b1y)/2×cos θ.

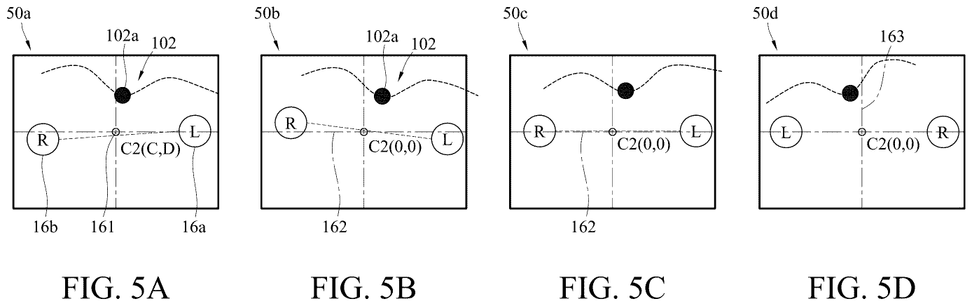

FIG. 5A to FIG. 5D are schematic diagrams illustrating a coordinate coplanar transformation of the rear back projection image according to the present disclosure. FIG. 5A shows a rear back projection image 50a obtained by the second imaging element 142a of the lower back projection module 142. The rear back projection image 50a includes the calibration target 16b on the left, the calibration target 16a on the right, and a notch 102 on the peripheral edge of the target object 10. The notch 102 has a notch vertex 102a, and the coordinates (C, D) of a midpoint C2 are obtained via the coordinates of the calibration target 16a and the coordinates of the calibration target 16b.

Then, by moving the coordinates (C, D) of the midpoint C2 to a calibration origin 161 of the rear calibration target projection image window 16d, the calibration target 16a, the calibration target 16b, the notch 102 and the notch vertex 102a on the peripheral edge of the target object 10 are moved synchronously to complete a coordinate translation transformation of the image to obtain a translation rear back projection image 50b as shown in FIG. 5B (that is, a (X, Y) coordinate system is transformed into a (X′, Y′) coordinate system).

In one embodiment, the coordinate translation transformation is calculated as follows:
coordinates of a point C of the calibration target 16b are (c1x, c1y),
coordinates of a point D of the calibration target 16a are (d1x, d1y),
coordinates of a point N2 of the notch vertex 102a are (n2x, n2y),
coordinates of the midpoint C2 are [(c1x+d1x)/2, (c1y+d1y)/2],
next, assume that the coordinates of the midpoint C2 are translated to the position of (0, 0) (and the calibration origin 161),
and the translation amounts are dx=−(c1x+d1x)/2, dy=−(c1y+d1y)/2.

The new coordinates after translation can be expressed as
(c1x+dx, c1y+dy) for the point C of the calibration target 16b,
(d1x+dx, d1y+dy) for the point D of the calibration target 16a, and
(n2x+dx, n2y+dy) for the point N2 of the notch vertex 102a.

After substituting the translation amounts dx and dy, the new coordinates are
[(c1x−d1x)/2, (c1y−d1y)/2)] for the point C of the calibration target 16b,
[(−c1x+d1x)/2, (−c1y+d1y)/2] for the point D of the calibration target 16a, and
[n1x−(c1x+d1x)/2, n1y−(c1y+d1y)/2] for the point N2 of the notch vertex 102a.

Next step, by taking the midpoint C2(0, 0) as the origin, the calibration target 16a and the calibration target 16b are rotated to a calibration horizontal axis 162, and the notch 102 and the notch vertex 102a of the peripheral edge of the target object 10 are synchronously rotated and converted, thereby completing a coordinate rotation transformation of the image to obtain a rotated rear back projection image 50c as shown in FIG. 5C (that is, the (X′, Y′) coordinate system is converted to a (X″, Y″) coordinate system).

In one embodiment, the coordinate rotation transformation is calculated as follows:
a slope of the calibration target 16a and the calibration target 16b is k2=(d1x−c1x)/(d1y−c1y),
an angle from the calibration horizontal axis 162 is θ2=tan⁻¹(k2) or 180−θ2,
the coordinates of any point in the (X′, Y′) coordinate system are converted into the (X″, Y″) coordinate system,
which can be expressed as

X″=X′x cos θ−Y′x sin θ,

Y″=X′x sin θ+Y′x cos θ.

Accordingly, the coordinate rotation transformation of the point N2 in the (X″, Y″) coordinate system can be expressed as

X″=[n2x−(c1x+d1x)/2]×cos θ−n2y−(c1y+d1y)/2×sin θ,

Y″=[n2x−(c1x+d1x)/2]×sin θ+n2y−(c1y+d1y)/2×cos θ.

Finally, by serving a calibration vertical axis 163 of the midpoint C2(0, 0) as a symmetry axis, the calibration target 16a and the calibration target 16b are mirror converted, and the notch 102 and the notch vertex 102a of the peripheral edge of the target object 10 are simultaneously mirrored to complete a coordinate mirror converted transformation of the coordinate system of the image to obtain a mirrored rear back projection image 50d as shown in FIG. 5D (i.e., the (X″, Y″) coordinate system is converted into a (X′″, Y″) coordinate system).

In one embodiment, the coordinate mirror converted transformation is calculated as follows:
under mirroring, the coordinates of any point in the image are converted to X′″=−X″, a mirrored coordinate transformation of the point N2 in the (X′″, Y′″) coordinate system can be expressed as

X″=−{[n2x−(c1x+d1x)/2]×cos θ−n2y−(c1y+d1y)/2×sin θ},

Y″=[n2x−(c1x+d1x)/2]×sin θ+n2y−(c1y+d1y)/2×cos θ.

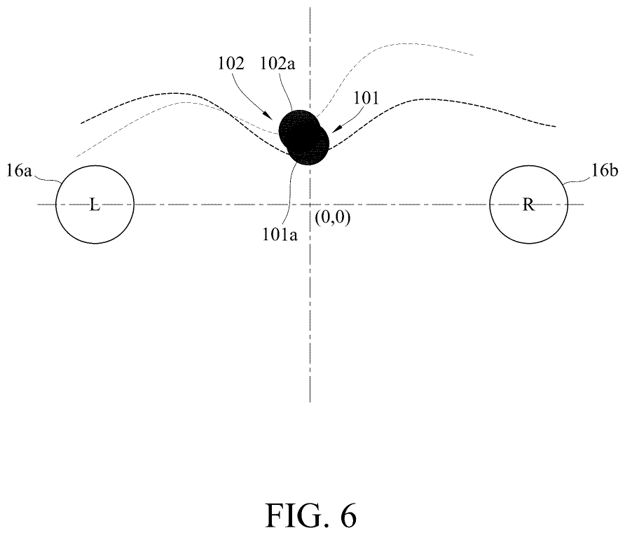

FIG. 6 is a schematic diagram illustrating a coordinate coplanar result of the front back projection image and the rear back projection image according to the present disclosure. In the schematic diagram of FIG. 6, by fixing the calibration target 16a and the calibration target 16b of FIG. 4C and FIG. 5D correspondingly (i.e., the two coordinate systems are aligned), the rotated front back projection image 40c of FIG. 4C and the mirrored rear back projection image 50d of FIG. 5D are overlapped with each other. Thus, the offset relationship or offset amount of the notch 101 and the notch 102 can be seen from the offset relationship between the notch vertex 101a and the notch vertex 102a (i.e., the coordinates of the two vertices are different).

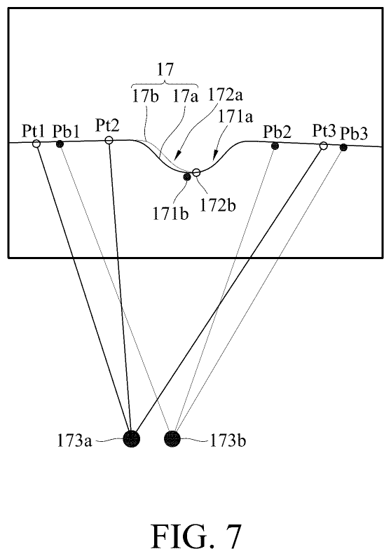

FIG. 7 is a schematic diagram of sampling points of circle given three points of the stacked wafer according to the present disclosure. FIG. 7 shows a peripheral edge of a stacked wafer 17 obtained by the coaxial back projection imaging device 14. However, in some embodiments, the peripheral edge of the stacked wafer 17 can be obtained by the side-light imaging device 15.

As shown in FIG. 7, the stacked wafer 17 includes a front wafer 17a and a rear wafer 17b. The front wafer 17a and the rear wafer 17b have a notch 171a and a notch 171b respectively.

The notch 171a and the notch 171b have a notch vertex 172a and a notch vertex 172b respectively.

In one embodiment, the peripheral edge of the front wafer 17a further includes sampling points Pt1, Pt2, Pt3, and the peripheral edge of the rear wafer 17b further includes sampling points Pb1, Pb2, Pb3, wherein the sampling points Pt1, Pt2, Pt3 are any points located on the peripheral edge of the front wafer 17a except in the notch 171a, and the sampling points Pb1, Pb2, Pb3 are any points located on the peripheral edge of the rear wafer 17b except in the notch 171b.

As shown in FIG. 7, a front wafer center 173a of the front wafer 17a can be calculated via the sampling points Pt1, Pt2, Pt3, and a rear wafer center 173b of the rear wafer 17b can be calculated via the sampling points Pb1, Pb2, Pb3. The specific calculation method can be explained as follows.

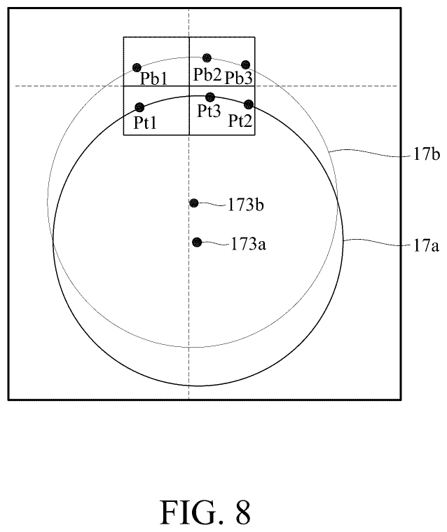

FIG. 8 is a schematic diagram of circle given three points of stacked wafers according to the present disclosure. After the coordinates of the three sampling points Pt1, Pt2, and Pt3 of the front wafer 17a and the coordinates of the three sampling points Pb1, Pb2, and Pb3 of the rear wafer 17b are processed by translation and rotation, the coordinate positions are expressed as follows:
coordinates of the three sampling points Pt1, Pt2, and Pt3 on the front wafer 17a are (pt1x, pt1y), (pt2x, pt2y), and (pt3x, pt3y) respectively,
coordinates of the three sampling points Pb1, Pb2, and Pb3 on the rear wafer 17b are (pb1x, pb1y), (pb2x, pb2y), and (pb3x, pb3y) respectively,
assume that the coordinates of a point W1 of the front wafer center 173a are (w1x, w1y) and the radius is R1,
assume that the coordinates of a point W2 of the rear wafer center 173b are (w2x, w2y) and the radius is R2.

For example, if the coordinates of the point W1 of the front wafer center 173a are (w1x, w1y) and the radius is R1, and the coordinates of the point W2 of the rear wafer center 173b are (w2x, w2y) and the radius is R2, then the formulas for finding the center of the circle are as follows:
front wafer 17a formula:

(pt1x−x)²+(pt1y−y)²=R² Formula (1)

(pt2x−x)²+(pt2y−y)²=R² Formula (2)

(pt3x−x)²+(pt3y−y)²=R² Formula (3)
rear wafer 17b formula:

(pb1x−x)²+(pb1y−y)²=R² Formula (4)

(pb2x−x)²+(pb2y−y)²-R² Formula (5)

(pb3x−x)²+(pb3y−y)²=R² Formula (6).

Next, assume
a=2×(pt3x−pt2x);
b=2×(pt3y−pt2y);
c=(pt3x)²−(pt2x)²+(pt3y)²−(pt2y)²;
e=2×(pt2x−pt1x);
f=2×(pt2y−pt1y);
g=(pt2x)²−(pt1x)²+(pt2y)²−(pt1y)²,
then the coordinates of the front wafer center 173a are solved as
w1x=(g×b−c×f)/(e×b−a×f);
w1y−(a×g−c×e)/(a×f−b×e);
radius R1=sqrt ((w1x−pt1x)²+(w1y−pt1y)²).

Similarly, assume
a′=2×(pb3x−pb2x);
b′=2×(pb3y−pb2y);
c′=(pb3x)²−(pb2x)²+(pb3y)²−(pb2y)²;
e′=2×(pb2x−pb1x);
f=2×(pb2y−pb1y);
g′=(pb2x)²−(pb1x)²+(pb2y)²−(pb1y)²;
then the coordinates of the rear wafer center 173b are solved as
w2x=(g′×b′−c′×f′)/(e′×b′−a′×f′)
w2y=(a′×g′−c′×e′)/(a′×f−b′×e′)
radius R2=sqrt((w2x−ptb1x)²+(w2y−pb1y)²).

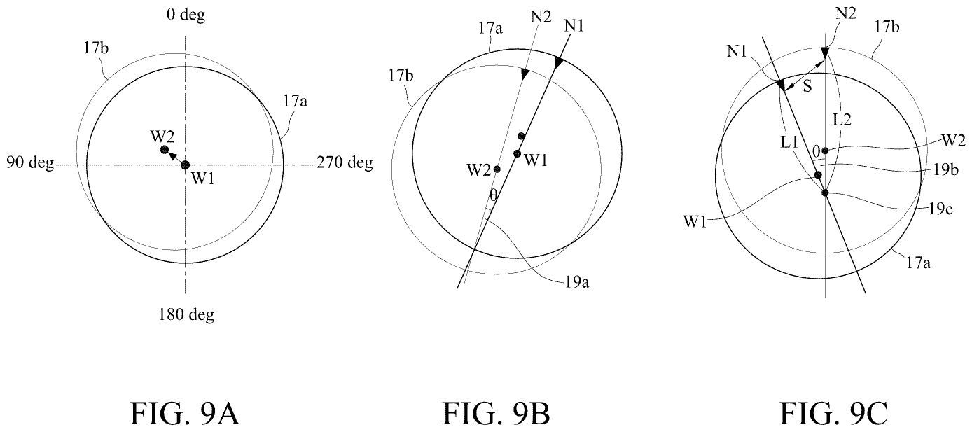

FIG. 9A is a schematic diagram illustrating a calculation of center offset of stacked wafers according to the present disclosure. Specifically, FIG. 9A shows a center offset length and a center offset vector of the front wafer center 173a (or the center W1) of the front wafer 17a relative to the rear wafer center 173b (or the center W2) of the rear wafer 17b. As mentioned above, after the calculation of circle given three points, the coordinates of the front wafer center 173a are (w1x, w1y), and the coordinates of the rear wafer center 173b are (w2x, w2y). Then the center offset length and the center offset vector are calculated as follows:

center offset length=sqrt[(w1x−w2x)²+(w1y−w2y)²],

center offset vector=W2−W1=(w2x−w1x,w2y−w1y).

FIG. 9B is a schematic diagram illustrating a calculation of intersection angle of slope of the notches of stacked wafers according to the present disclosure. Specifically, FIG. 9B shows the front wafer center 173a (or the center W1) of the front wafer 17a, the notch vertex N1 of the front wafer 17a, the rear wafer center 173b (or the center W2) of the rear wafer 17b, and the notch vertex N2 of the rear wafer 17b, whereby a connection line N1W1 (a straight line) of the notch vertex N1 and the center W1 and a connection line N2W2 (a straight line) of the notch vertex N2 and the center W2 form an included angle 19a, and θ value of the included angle 19a is calculated as follows:
coordinates of the notch vertex N1 are (n1x, n1y), which are coordinately converted as (n1x′, n1y′);
coordinates of the notch vertex N2 are (n2x, n2y), which are coordinately converted as (n2x′, n2y′);
coordinates of the center W1 are (w1x, w1y);
coordinates of the center W2 are (w2x, w2y);
then the slope of N1W1: k1=(n1x′−w1x)/(n1y′−w1y), the slope of N2W2: k2=(n2x′−w2x)/(n2y′−w2Y);
the θ value of the included angle 19a is solved to be tan⁻¹[(k1−k2)/(1+k1×k2)] or 180−θ.

FIG. 9C is a schematic diagram illustrating a notch image arc length approximation method of stacked wafers according to the present disclosure. FIG. 9C shows the center W1 of the front wafer 17a, the notch vertex N1 of the front wafer 17a, the center W2 of the rear wafer 17b, and the notch vertex N2 of the rear wafer 17b, whereby the connection line N1W1 and the connection line N2W2 are crossed at an intersection point 19c and form an included angle 19b. Between the notch vertex N1 and the included angle 19b has a distance L1, between the notch vertex N2 and the included angle 19b has a distance L2, and between the notch vertex N1 and the notch vertex N2 has a connecting arc length S and a height difference d, for which the 0 value of the included angle 19b is calculated as follows:
coordinates of the notch vertex N1 are (n1x, n1y), which are coordinately converted as (n1x′, n1y′);
coordinates of the notch vertex N2 are (n2x, n2y), which are coordinately converted as (n2x′, n2y′);
radius lengths of the front wafer 17a and the rear wafer 17b are R;
the connecting arc length S is S=(n2x′−n1x′, n2y′−n1y′)−(R−d)θ;
thereby, when L1 and L2 approximate R-d, the 0 value of the included angle 19b is solved as S/(R−d)=sqrt[(n2x′−n1x′)²+(n2y′−n1y′)²]/(R−d).

In view of the above, the wafer inspection system of the present disclosure uses the upper back projection module and the lower back projection module of the coaxial back projection imaging device to guide the coaxial light to the upper and lower sides of the peripheral edges of the stacked wafers to respectively obtain the front back projection images and the rear back projection images of the peripheral edges, and the coordinate systems of the front back projection images and the rear back projection images are converted into the same coordinate system to accurately calculate the position of the notch, the angle of the notch, the center of the wafer and the trend of overall wafer outer edge offset. In addition, the present disclosure also uses a side-light imaging device to guide the side light emitted by the side-light imaging device to the sides of the peripheral edges of the stacked wafers, thereby acquiring high-contrast images of the peripheral edges.

The above embodiments are provided for illustrating the principles of the present disclosure and its technical effect, and should not be construed as to limit the present disclosure in any way. The above embodiments can be modified by one of ordinary skill in the art without departing from the spirit and scope of the present disclosure. Therefore, the scope claimed of the present disclosure should be defined by the following claims.

What is claimed is:

1. A wafer inspection system, comprising:
a first platform for placing a target object thereon;
a second platform moveable relative to the first platform, wherein the target object on the first platform is moveable relative to the second platform;
a third platform moveable relative to the first platform and located on a side of the second platform;
a coaxial back projection imaging device including an upper back projection module and a lower back projection module disposed on the second platform, wherein a coaxial light is guided to an upper side and a lower side of a peripheral edge of the target object by the upper back projection module and the lower back projection module to obtain a front back projection image and a rear back projection image of the peripheral edge respectively; and
a side-light imaging device disposed on the third platform, wherein a side light emitted by the side-light imaging device is guided to a side of the peripheral edge of the target object to obtain a contrast image of the peripheral edge.

2. The wafer inspection system of claim 1, wherein the upper back projection module and the lower back projection module each has a corresponding light splitting element, coaxial light source and imaging element, wherein between the peripheral edge and the corresponding light splitting element and the coaxial light source is formed with a first imaging path, and between the corresponding light splitting element and the imaging element is formed with a second imaging path.

3. The wafer inspection system of claim 2, wherein the coaxial light sources of the upper back projection module and the lower back projection module are relatively disposed on a same axis, and the light splitting elements of the upper back projection module and the lower back projection module are disposed between the coaxial light sources on the axis.

4. The wafer inspection system of claim 2, wherein the first imaging paths of the upper back projection module and the lower back projection module are respectively perpendicular to the second imaging paths of the upper back projection module and the lower back projection module.

5. The wafer inspection system of claim 1, further comprising a coordinate calibration device having at least two targets, a front calibration target projection image window, and a rear calibration target projection image window, allowing the front back projection image and the rear back projection image to be formed with at least two reference points, wherein the front back projection image and the rear back projection image are converted into coplanar coordinates via the at least two reference points.

6. The wafer inspection system of claim 5, wherein the coordinate calibration device is disposed on the third platform and adjacent to the side-light imaging device.

7. The wafer inspection system of claim 1, wherein the side-light imaging device has a side light source and an image capturing element, such that the side light source, the image capturing element and the peripheral edge form a third imaging path.

8. A method of inspecting a wafer, comprising:
providing the wafer inspection system of claim 1;
disposing stacked upper wafer and lower wafer on the first platform;
obtaining a front back projection image and a rear back projection image of peripheral edges of the upper wafer and the lower wafer by the coaxial back projection imaging device;
obtaining a contrast image of the peripheral edges of the upper wafer and the lower wafer by the side-light imaging device;
detecting the front back projection image, the rear back projection image and the contrast image to obtain coordinates of notch vertices and coordinates of a plurality of feature points of the peripheral edges of the upper wafer and the lower wafer from the front back projection image, the rear back projection image and the contrast image;
calculating coordinates of a center of the upper wafer and the lower wafer respectively via the coordinates of the plurality of feature points; and
calculating a positional offset between the upper wafer and the lower wafer via the coordinates of the notch vertices and the coordinates of the centers.

9. The method of claim 8, wherein the coordinates of the notch vertex and the coordinates of the center of the upper wafer form a first straight line, and the coordinates of the notch vertex and the coordinates of the center of the lower wafer form a second straight line, allowing an included angle value to be calculated via a slope of the first straight line and a slope of the second straight line.

10. The method of claim 8, wherein between the coordinates of the notch vertex of the upper wafer and the coordinates of the notch vertex of the lower wafer has a connecting arc length value, allowing an included angle value to be calculated via a ratio of the connecting arc length value and a difference between a radius length and a notch height of the upper wafer and the lower wafer.
